(19) United States
(12) Patent Application Publication
(10) Pub. No.: US 2023/0103775 A1
(43) Pub. Date: Apr. 6, 2023

(54) METHOD AND APPARATUS FOR COMMUNICATION SYSTEM SERVING VEHICLES

(71) Applicant: NOKIA TECHNOLOGIES OY, Espoo (FI)

(72) Inventors: Pallab GUPTA, Bangalore (IN); Saurabh KHARE, Bangalore (IN); István Zsolt KOVÁCS, Aalborg (DK); Gerald KUNZMANN, Munich (DE); Yannick LAIR, Voisins le Bretonneux (FR); Konstantinos SAMDANIS, Munich (DE); Anja JERICHOW, Grafing bei München (DE)

(73) Assignee: NOKIA TECHNOLOGIES OY, Espoo (FI)

(21) Appl. No.: 17/936,978

(22) Filed: Sep. 30, 2022

(30) Foreign Application Priority Data
Sep. 30, 2021 (IN) 202141044410

(51) Int. Cl. G01S 5/00; H04W 64/00; H04W 8/20

(52) U.S. Cl. CPC G01S 5/0036; H04W 8/20; H04W 64/00; H04W 84/06

(57) ABSTRACT

A technique comprising: receiving, at a data analytics function of a core network of a mobile communication system, travel path data from a traffic management entity, wherein the travel path data indicates a travel path for a vehicle comprising a user equipment registered to the mobile communication system; receiving, at the data analytics function, location data for the vehicle transmitted by the user equipment; and in response to detecting an inconsistency between the travel path data for the vehicle and the location data for the vehicle transmitted by the user equipment, outputting a travel path deviation report for the traffic management entity.

### CROSS-REFERENCE TO RELATED APPLICATIONS

This application claims priority to Indian Patent Application No. 202141044410, filed Sep. 30, 2021, the entire contents of which are incorporated herein by reference.

### TECHNICAL FIELD

The present disclosure relates to apparatus, a method, and a computer program, and in particular to apparatus, methods and computer programs for a communication system serving vehicles.

### BACKGROUND

The operation of vehicles (such as unmanned aerial vehicles) may involve a traffic management entity authorising travel paths for vehicles. Vehicles may comprise a user equipment registered to a mobile communications system.

### SUMMARY

Apparatus comprising: means for receiving travel path data from a traffic management entity, wherein the travel path data indicates a travel path for a vehicle comprising a user equipment registered to a mobile communication system; means for receiving location data for the vehicle transmitted by the user equipment; and means for, in response to detecting an inconsistency between the travel path data for the vehicle and the location data for the vehicle transmitted by the user equipment, outputting a travel path deviation report for the traffic management entity.

The location data for the vehicle may comprise travel path reporting data transmitted by the user equipment.

The travel path reporting data transmitted by the user equipment may be transmitted by the user equipment as one or more messages indicating the location and arrival time for one or more waypoints.

The travel path reporting data may be transmitted periodically by the user equipment.

The location data for the vehicle may comprise location data transmitted by the user equipment together with measurements related to the radio access network.

The apparatus may comprise means for receiving the travel path data from the traffic management entity from a network exposure function of a core network of the mobile communication system, and configuration of the user equipment to transmit location data for the vehicle may be triggered by a message from the network exposure function to an access management function for the user equipment.

The apparatus may comprise means for sending, to an access management function for the user equipment, a message triggering configuration of the user equipment to transmit location data for the vehicle.

The apparatus may comprise means for receiving the travel path data from the traffic management entity from a network exposure function of a core network of the mobile communication system; means for receiving location data for the user equipment from a gateway location mobile centre; and means for, in response to detecting that the location data for the user equipment from the gateway location mobile centre is not consistent with the location data for the vehicle transmitted by the user equipment; reporting the inconsistency to the network exposure function.

The vehicle may be an aerial vehicle.

The location data for the aerial vehicle transmitted by the user equipment may indicate longitude, latitude and height of the aerial vehicle.

The inconsistency between the travel path data for the vehicle from the traffic management entity and the location data for the vehicle transmitted by the user equipment may comprise a deviation outside a threshold range of deviation.

The threshold range of deviation may be based on information from the traffic management entity.

The apparatus may comprise a network data analytics function or a management data analytics function of the mobile communication system.

Apparatus comprising: means for receiving travel path data from a traffic management entity, wherein the travel path data indicates a travel path for a vehicle comprising a user equipment registered to a mobile communication system; means for sending the travel path data to a data analytics function of a core network of the mobile communication system; and means for, in response to receiving a travel path deviation report from the data analytics function, sending the travel path deviation report to the traffic management entity.

The apparatus may comprise: means for, in response to receiving the travel path data from the traffic management entity, sending, to an access management function for the user equipment, a message triggering configuration of the user equipment to transmit location data for the vehicle, for use by the data analytics function to check against the travel path data.

The location data for the vehicle may comprise travel path reporting data for the vehicle.

The message triggering configuration of the user equipment to transmit travel path reporting data may comprise a message triggering the user equipment to send one or more messages indicating the location and arrival time for one or waypoints for the vehicle.

The apparatus may comprise a network function supported within a network exposure function of the mobile communication system.

The vehicle may be an aerial vehicle.

Apparatus comprising: at least one processor; and at least one memory including computer program code, the at least one memory and computer program code configured to, with the at least one processor, cause the apparatus to perform: receiving travel path data from a traffic management entity, wherein the travel path data indicates a travel path for a vehicle comprising a user equipment registered to a mobile communication system; receiving location data for the vehicle transmitted by the user equipment; and in response to detecting an inconsistency between the travel path data for the vehicle and the location data for the vehicle transmitted by the user equipment, outputting a travel path deviation report for the traffic management entity.

The location data for the vehicle may comprise travel path reporting data transmitted by the user equipment.

The travel path reporting data transmitted by the user equipment may be transmitted by the user equipment as one or more messages indicating the location and arrival time for one or more waypoints.

The travel path reporting data may be transmitted periodically by the user equipment.

The location data for the vehicle may comprise location data transmitted by the user equipment together with measurements related to the radio access network.

The at least one memory and computer program code may be configured to, with the at least one processor, cause the apparatus to: receive the travel path data from the traffic management entity from a network exposure function of a core network of the mobile communication system; and wherein configuration of the user equipment to transmit location data for the vehicle is triggered by a message from the network exposure function to an access management function for the user equipment.

The at least one memory and computer program code may be configured to, with the at least one processor, cause the apparatus to: send, to an access management function for the user equipment, a message triggering configuration of the user equipment to transmit location data for the vehicle.

The at least one memory and computer program code may be configured to, with the at least one processor, cause the apparatus to: receive the travel path data from the traffic management entity from a network exposure function of a core network of the mobile communication system; receive location data for the user equipment from a gateway location mobile centre; and, in response to detecting that the location data for the user equipment from the gateway location mobile centre is not consistent with the location data for the vehicle transmitted by the user equipment; report the inconsistency to the network exposure function.

The vehicle may be an aerial vehicle.

The location data for the aerial vehicle transmitted by the user equipment may indicate longitude, latitude and height of the aerial vehicle.

The inconsistency between the travel path data for the vehicle from the traffic management entity and the location data for the vehicle transmitted by the user equipment may comprise a deviation outside a threshold range of deviation.

The threshold range of deviation may be based on information from the traffic management entity.

The apparatus may comprise a network data analytics function or a management data analytics function of the mobile communication system.

Apparatus comprising: at least one processor; and at least one memory including computer program code, the at least one memory and computer program code configured to, with the at least one processor, cause the apparatus to perform: receiving travel path data from a traffic management entity, wherein the travel path data indicates a travel path for a vehicle comprising a user equipment registered to a mobile communication system; sending the travel path data to a data analytics function of a core network of the mobile communication system; and in response to receiving a travel path deviation report from the data analytics function, sending the travel path deviation report to the traffic management entity.

The at least one memory and computer program code may be configured to, with the at least one processor, cause the apparatus to: in response to receiving the travel path data from the traffic management entity, send, to an access management function for the user equipment, a message triggering configuration of the user equipment to transmit location data for the vehicle, for use by the data analytics function to check against the travel path data.

The location data for the vehicle may comprise travel path reporting data for the vehicle.

The message triggering configuration of the user equipment to transmit travel path reporting data may comprise a message triggering the user equipment to send one or more messages indicating the location and arrival time for one or waypoints for the vehicle.

The apparatus may comprise a network function supported within a network exposure function of the mobile communication system.

The vehicle may be an aerial vehicle.

A method comprising: receiving, at a data analytics function of a core network of a mobile communication system, travel path data from a traffic management entity, wherein the travel path data indicates a travel path for a vehicle comprising a user equipment registered to the mobile communication system; receiving, at the data analytics function, location data for the vehicle transmitted by the user equipment; and in response to detecting an inconsistency between the travel path data for the vehicle and the location data for the vehicle transmitted by the user equipment, outputting a travel path deviation report for the traffic management entity.

The location data for the vehicle may comprise travel path reporting data transmitted by the user equipment.

The travel path reporting data transmitted by the user equipment may be transmitted by the user equipment as one or more messages indicating the location and arrival time for one or more waypoints.

The travel path reporting data may be transmitted periodically by the user equipment.

The location data for the vehicle may comprise location data transmitted by the user equipment together with measurements related to the radio access network.

The data analytics function may receive the travel path data from a network exposure function of the core network, and configuration of the user equipment to transmit location data for the vehicle may be triggered by a message from the network exposure function to an access management function for the user equipment.

Configuration of the user equipment to transmit location data for the vehicle may be triggered by a message from the analytics function to an access management function for the user equipment.

The data analytics function may receive the travel path data for the vehicle from a network exposure function of the core network; and the method may further comprise receiving, at the data analytics function, location data for the user equipment from a gateway location mobile centre; and in response to detecting that the location data for the user equipment from the gateway location mobile centre is not consistent with the location data for the vehicle transmitted by the user equipment; reporting the inconsistency to the network exposure function.

The vehicle may be an aerial vehicle.

The location data for the aerial vehicle transmitted by the user equipment may indicate longitude, latitude and height of the aerial vehicle.

The inconsistency between the travel path data for the vehicle authorized by the traffic management entity and the location data for the vehicle transmitted by the user equipment may comprise a deviation outside a threshold range of deviation.

The threshold range of deviation may be based on information from the traffic management entity.

The data analytics function may comprise a network data analytics function or a management data analytics function.

A method comprising: receiving, at a network exposure function of a core network of a mobile communication system, travel path data from a traffic management entity, wherein the travel path data indicates a travel path for a vehicle comprising a user equipment registered to the mobile communication system; sending the travel path data to a data analytics function of the core network; and in response to receiving a travel path deviation report from the data analytics function, sending the travel path deviation report to the traffic management entity.

The method may comprise: in response to receiving the travel path data from the traffic management entity, sending from the network exposure function to an access management function for the user equipment a message triggering configuration of the user equipment to transmit location data for the vehicle, for use by the data analytics function to check against the travel path data.

The location data for the vehicle may comprise travel path reporting data for the vehicle.

The message triggering configuration of the user equipment to transmit travel path reporting data may comprise a message triggering the user equipment to send one or more messages indicating the location and arrival time for one or waypoints for the vehicle.

Receiving travel path data at the network exposure function may comprise receiving the travel path data at a network function supported within the network exposure function.

The vehicle may be an aerial vehicle.

Apparatus comprising: receiving circuitry for receiving travel path data from a traffic management entity, wherein the travel path data indicates a travel path for a vehicle comprising a user equipment registered to a mobile communication system; receiving circuitry for receiving location data for the vehicle transmitted by the user equipment; and outputting circuitry for, in response to detecting an inconsistency between the travel path data for the vehicle and the location data for the vehicle transmitted by the user equipment, outputting a travel path deviation report for the traffic management entity.

Apparatus comprising: receiving circuitry for receiving travel path data from a traffic management entity, wherein the travel path data indicates a travel path for a vehicle comprising a user equipment registered to a mobile communication system; sending circuitry for sending the travel path data to a data analytics function of a core network of the mobile communication system; and sending circuitry for, in response to receiving a travel path deviation report from the data analytics function, sending the travel path deviation report to the traffic management entity.

A computer readable medium comprising program instructions stored thereon for performing: receiving travel path data from a traffic management entity, wherein the travel path data indicates a travel path for a vehicle comprising a user equipment registered to a mobile communication system; receiving location data for the vehicle transmitted by the user equipment; and in response to detecting an inconsistency between the travel path data for the vehicle and the location data for the vehicle transmitted by the user equipment, outputting a travel path deviation report for the traffic management entity.

A computer readable medium comprising program instructions stored thereon for performing: receiving travel path data from a traffic management entity, wherein the travel path data indicates a travel path for a vehicle comprising a user equipment registered to a mobile communication system; sending the travel path data to a data analytics function of a core network of the mobile communication system; and in response to receiving a travel path deviation report from the data analytics function, sending the travel path deviation report to the traffic management entity.

A non-transitory computer readable medium comprising program instructions stored thereon for performing: receiving travel path data from a traffic management entity, wherein the travel path data indicates a travel path for a vehicle comprising a user equipment registered to a mobile communication system; receiving location data for the vehicle transmitted by the user equipment; and in response to detecting an inconsistency between the travel path data for the vehicle and the location data for the vehicle transmitted by the user equipment, outputting a travel path deviation report for the traffic management entity.

A non-transitory computer readable medium comprising program instructions stored thereon for performing: receiving travel path data from a traffic management entity, wherein the travel path data indicates a travel path for a vehicle comprising a user equipment registered to a mobile communication system; sending the travel path data to a data analytics function of a core network of the mobile communication system; and in response to receiving a travel path deviation report from the data analytics function, sending the travel path deviation report to the traffic management entity.

A computer program comprising computer executable code which when run on at least one processor is configured to cause an apparatus at least to: receive travel path data from a traffic management entity, wherein the travel path data indicates a travel path for a vehicle comprising a user equipment registered to a mobile communication system; receive location data for the vehicle transmitted by the user equipment; and in response to detecting an inconsistency between the travel path data for the vehicle and the location data for the vehicle transmitted by the user equipment, output a travel path deviation report for the traffic management entity.

A computer program comprising computer executable code which when run on at least one processor is configured to cause an apparatus at least to: receive travel path data from a traffic management entity, wherein the travel path data indicates a travel path for a vehicle comprising a user equipment registered to a mobile communication system; send the travel path data to a data analytics function of a core network of the mobile communication system; and in response to receiving a travel path deviation report from the data analytics function, send the travel path deviation report to the traffic management entity.

In the context of the present disclosure travel path is used to indicate a path followed by a moving vehicle or, in other words, a moving path. Travel path and moving path are used in this text interchangeably.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described in further detail, by way of example only, with reference to the following examples and accompanying drawings, in which:

FIG. 1 illustrates an example system to which embodiments may be applied;

FIG. 2 shows a representation of an example of operations at components of FIG. 1 according to example embodiments;

FIG. 3 shows a representation of an example of operations at components of FIG. 1 subsequent to the operations of FIG. 2 according to example embodiments;

FIG. 4 shows a representation of another example of operations at components of FIG. 1 according to example embodiments;

FIG. 5 shows a representation of an example of operations at components of FIG. 1 subsequent to the operations of FIG. 4 according to example embodiments;

FIG. 6 shows a representation of an example of operations at a data analytics function according to example embodiments;

FIG. 7 shows a representation of an example of apparatus for implementing operations at the data analytics function or implementing operations at the network exposure function according to example embodiments; and

FIG. 8 shows a representation of an example of non-volatile memory media.

### DETAILED DESCRIPTION

The following description of example embodiments makes mention of mobile communication systems operating according to specific 3GPP protocols (3GPP 5G protocol), but the underlying technique is also applicable to mobile communication systems operating according to other protocols, such as more evolved 3GPP protocols.

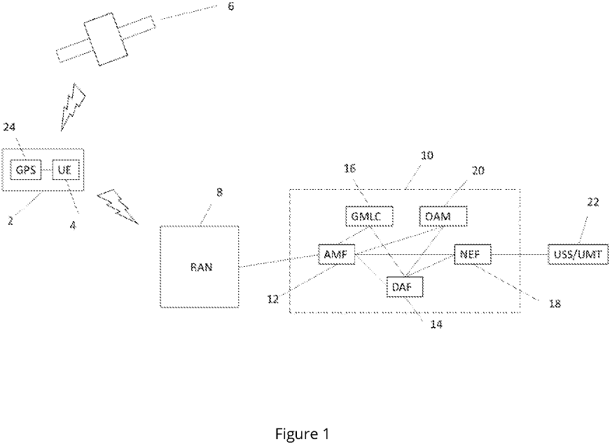

FIG. 1 shows a representation of an example of a system to which embodiments may be applied. For conciseness, FIG. 1 focusses on those components of the system having a primary role in the example embodiments described below, but the system may comprise other components.

The connections shown in FIG. 1 are logical connections; the actual physical connections may be different.

The radio access network 8 of FIG. 1 comprises a plurality of access nodes (such as (e/g)NodeB) operating a plurality of cells serving both aerial user equipments (e.g. user equipments in unmanned aerial vehicles (UAVs)) and non-aerial user equipments. The cells may be macro cells (or umbrella cells) which are large cells, usually having a diameter of up to tens of kilometers, or smaller cells such as micro-, femto- or picocells.

The (e/g)NodeB is a computing device configured to control radio resources of the 3GPP (3^{rd} Generation Partnership Project) mobile communication system. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user equipments. The antenna unit may comprise a plurality of antennas or antenna elements. The (e/g)NodeBs are further connected to the core network 10 (CN or NGC (next generation core). The (e/g)NodeBs are connected to one or more user-plane entities of the core network 10 for routing and forwarding user data packets and for providing connectivity of user equipments to one or more external packet data networks, and to one or more control-plane entities of the core network for controlling access and mobility of the user equipments.

5G enables using multiple input - multiple output (MIMO) antennas. 5G enables using macro sites operating in co-operation with smaller stations and employing a variety of radio technologies depending on service needs, use cases and/or spectrum available. 5G may have multiple radio interfaces, e.g. below 6 GHz or above 24 GHz, cmWave and mmWave, and is also integrable with existing legacy radio access technologies, such as Long Term Evolution (LTE). Integration with LTE may be implemented as a system, where macro coverage is provided by the LTE and 5G radio interface access comes from small cells by aggregation to the LTE. In other words, 5G can support both inter-RAT operability (such as LTE-5G) and inter-RI operability (inter-radio interface operability, such as below 6 GHz -cmWave, 6 or above 24 GHz - cmWave and mmWave). One of the concepts used in 5G networks is network slicing in which multiple independent and dedicated virtual sub-networks (network instances) are created within the same infrastructure to run services that have different requirements on latency, reliability, throughput and mobility.

Low latency applications and services may be facilitated in 5G by bringing the content close to the radio which leads to local break out and multi-access edge computing (MEC). 5G enables analytics and knowledge generation to occur at the source of the data.

The mobile communication system is also able to communicate with other networks, such as a public switched telephone network, or a VoIP (Voice over Internet Protocol) network, or the Internet, or a private network, or utilize services provided by them.

In the following examples solutions will be described, which refer to unmanned aerial vehicles (UAV). However, the described solutions can be as well applied to any kind of vehicle, such as cars or any other type of terrestrial or aquatic vehicles or drones. Flight path in case of a terrestrial / aquatic vehicle can be interpreted as moving or travel path, aerial traffic management entity can be replaced by traffic management entity, aerial traffic can be replaced by traffic, aerial UE can be replaced by UE.

In these example embodiments, an unmanned aerial vehicle (UAV) 2 comprises a component (UE) 4 providing user equipment functionality in a 3GPP mobile communication system also comprising radio access network 8 and core network 10. The UAV 2 also comprises a global positioning system (GPS) component 24 for receiving GPS signals from a system of GPS satellites 6, and determining the location of the UAV 2 based on the received GPS signals.

The UAV 2 may be identified by a CAA (civil aviation authority) UAV ID.

The UAV 2 may be part of an unmanned aerial system (UAS) also comprising a UAV controller (not shown) for controlling the UAV 2. Critical communication between the UAV 2 and the UAV controller (e.g. command and control (C2)) may or may not be via the mobile communication system.

The UAV 2 may start a flight mission after flight path or in general moving path authorisation is performed by an aerial traffic management entity or in general traffic management entity 22. In this example, the aerial traffic management entity 22 is a USS/UTM (UAS Service Supplier/UAS Traffic Management) entity) that provides services to support the safe and efficient use of airspace by providing services to the operator of a UAS in meeting operational requirements. In this example, the USS/UTM 22 is external to the mobile communication system.

In this example, the USS/UTM 22 acts as an external application function (AF) in relation to the 3GPP mobile communication system. The USS/UTM 22 can access 3GPP exposed services using one or more public identifiers for the UE 4 forming part of the UAV 2.

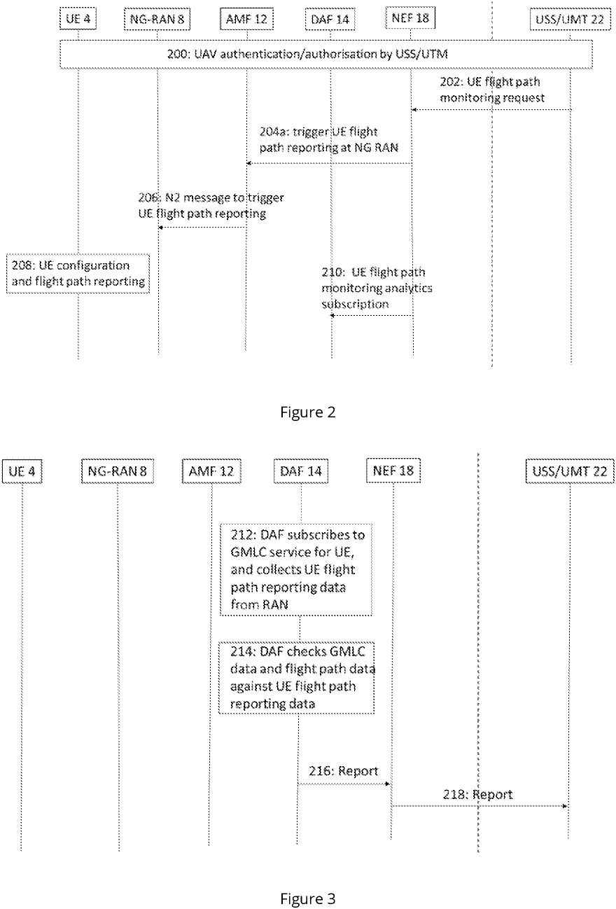

FIG. 2 shows a representation of example operations at components shown in FIG. 1 according to example embodiments.

OPERATION 200: The operations shown in FIG. 2 begin with authentication/authorisation of the UAV identifier (CAA-level UAV ID) for UAV 2 by the USS/UMT 22 via the 3GPP mobile communication system including UE 4. This authentication may happen at the time of establishing a packet data unit (PDU) session between the UE 4 of UAV 2 and a UAV controller (e.g. another user equipment at the UAV controller), in the event, for example, that critical communications between the UAV 2 and a UAV controller use the 3GPP mobile communication system. Alternatively, this authentication may happen at the time of registering the UE 4 of the UAV 2 to the 3GPP mobile communication system. UE 4 of UAV 2 includes the CAA-level UAV ID in a request to register to the 3GPP mobile communication system, and in a request to establish a PDU session.

The 3GPP mobile communication system provides one or more public identifiers for the UE 4 of UAV 2 to the USS/UTM 22. The one or more public identifiers may comprise, for example, a GPSI (Generic Public Subscription Identifier) and/or an IP address for UE 4 of UAV 2. USS/UTM 22 uses the one or more public identifiers for UE 4 of UAV 2 to access 3GPP exposed services for UE 4.

Alternatively, the operator of the UAS including the UAV 2 provides the USS/UTM 22 with MNO (mobile network operator) information identifying the 3GPP mobile communication system serving UE 4 of UAV 2, and one or more public identifiers for UE 4 of UAV 2; and USS/UTM 22 uses this information and the public identifiers to access 3GPP exposed services for UE 4 of UAV 2.

OPERATION 202: USS/UTM 22 sends a UE flight path monitoring request to a UAS network function (NF) supported within a network exposure function (NEF) 18 of the core network 10 of the 3GPP mobile communication system. In this example, the UE flight path monitoring request includes the following information elements: a public identifier for UE 4; data indicating an authorised flight path for UAV 2; a callback URI (uniform resource identifier); and data indicating an acceptable degree of deviation from the authorised flight path. In this example, the UE flight path monitoring request relates to a single UAV 2, but the request may include the above information elements for a plurality of UAVs comprising respective UEs registered to the 3GPP mobile communication system. The data from USS-UTM 22 indicating the authorised flight path for UAV 2 may indicate longitude, latitude and height for each of a plurality of way points (intermediate points) along the authorised flight path, together with an estimated arrival time for each way point. The acceptable degree of deviation from the authorised flight path may, for example, be expressed in absolute or relative units as an acceptable three-dimension (3D) distance deviation (maximum distance deviation away from a way point at the expected time of arrival at the way point), or may be expressed in absolute or relative units as an acceptable time deviation (maximum deviation of the actual time of arrival at a way point from the expected time of arrival at the way point). The UE flight path monitoring request may also comprise an information element indicating one or more variations of the degree of acceptable deviation in dependence on one or more conditions (e.g. weather conditions). For example, this information element may indicate one or more functions by which to calculate a degree of acceptable deviation dependent on one or more input conditions.

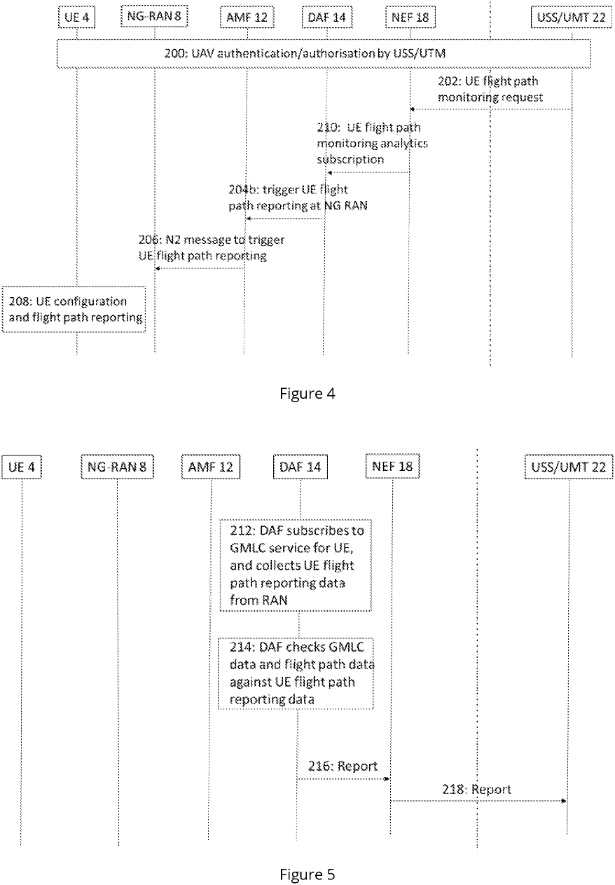

OPERATION 204A: In this example, UAS-NF supported within NEF 18 directs, to an access and mobility management function (AMF) 12 for UE 4, a message triggering AMF 12 to send a N2 interface (interface between AMF 12 and a gNodeB of the RAN 8) message to RAN 8 triggering RAN 8 to configure UE 4 for flight path reporting . According to an alternative example shown in FIG. 4 and described further below, the DAF 14 (instead of NEF 18) sends this kind of message to AMF 12.

This example makes use of the kind of flight path reporting mechanism first introduced by 3GPP Release 15 for the purpose of enabling the provision of early resource reservation in cells suitable for a handover of the UAV-UE, and thereby achieve a higher quality of service (QoS) for the UAV-UE. This example makes a new use of this flight path reporting mechanism. The flight path reporting mechanism involves RAN sending a UEInformationRequest message including flightPathInformationReq parameter to the UAV-UE 4, and the UAV-UE 4 replying with a UEInformationResponse message including data for up to 20 waypoints. The data for each waypoint is composed of: 3D location data for the waypoint; and a time stamp indicating the expected time of arrival of the UAV-UE 4 at the waypoint with a maximum of one second granularity. In this example, UAV-UE 4 may send UEInformationResponse messages periodically in response to the UEInformationRequest message from RAN, each UEInformationResponse message including data for a respective set of waypoints.

OPERATION 206: In response to receiving this message from UAS-NF supported within NEF 18, AMF 12 sends a N2 message to NG-RAN 8 triggering NG-RAN 8 to configure UE 4 for flight path reporting.

OPERATION 208: In response to receiving this N2 message from AMF 12, RAN 8 configures UE 4 of UAV 2 for flight path reporting, as described above,; and UE 4 transmits one or more flight path reporting messages of the kind described above, according to this configuration.

As mentioned above, each UEInformationResponse message transmitted by UE 4 of UAV 2 to the RAN node serving UAV-UE 4 indicates 3D location and estimated arrival time for each of one or more flight path way-points (intermediate points). The 3D location data for a waypoint comprises longitude, latitude and height for the waypoint.

OPERATION 210: UAS-NF supported within NEF 18 subscribes to UE flight path monitoring analytics service provided by DAF 14. DAF 14 may be a network data analytics function (NWDAF) at a network layer of the core network 10, or a management data analytics function (MDAF) at the management layer of the core network 10. The subscription request includes the following information elements: an analytics identifier indicating the UE flight path monitoring analytics service; and the above-mentioned information elements from the UE flight path monitoring request received at UAS-NF supported within NEF 18 from USS/UTM 22.

OPERATION 212: DAF 14 subscribes to GMLC (Gateway Mobile Location Centre) 16 service for UE 4 of UAV 2, and collects from RAN 8 (via operations, administration and maintenance (OAM) function 20) the flight path reporting data transmitted by UE 4. The location data provided by the GMLC 16 service for UE 4 of UAV 2 indicates a location for UE 4 of UAV 2 based (according to e.g. the positioning procedures described in 3GPP TS 23.273) on measurements by the radio access network of transmissions made by UE 4 of UAV 2, and/or measurements by UE 4 of UAV 2 of transmissions by the radio access network 8.

OPERATION 214: DAF 14 checks the location data provided by the GMLC service for UE 4 of UAV 2 against the flight path reporting data for UAV 2 provided by UE 4 of UAV 2. If there is no inconsistency, DAF 14 proceeds to check the flight path reporting data for UAV 2 provided by UE 4 of UAV 2 against the authorised flight path data from USS/UTM 22 indicating the authorised flight path for UAV 2. As mentioned in more detail further below, the checking of the flight path reporting data for UAV 2 provided by UE 4 of UAV 2 against the authorised flight path data from USS/UTM 22 for UAV 2 may take into account an indication in the information from USS/UTM 22 of an acceptable degree of deviation from the authorised flight path.

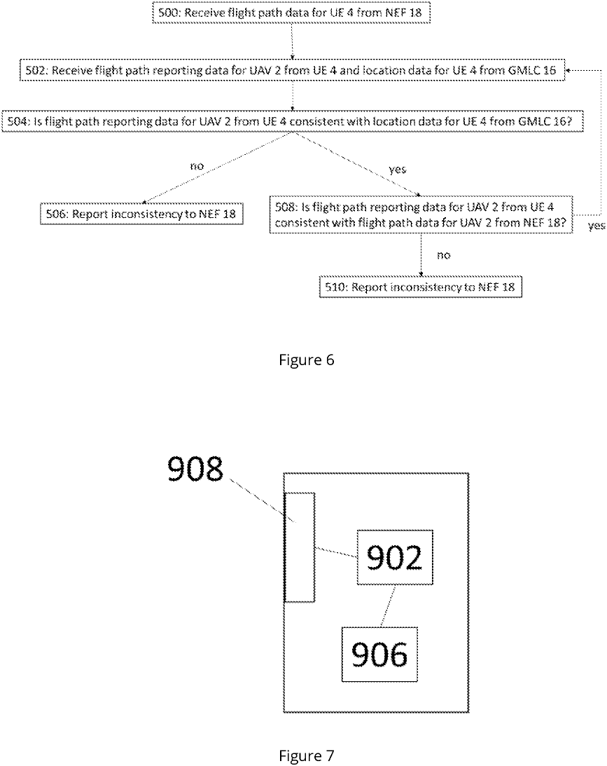

FIG. 6 shows a representation of the checking process at DAF 14. DAF 14 receives from UAS-NF supported within NEF 18 the data indicating the flight path authorised by USS/UTM 22 for UAV 2 (STEP 500). DAF 14 receives periodic location report from GMLC containing location data for UE 4 of UAV 2 and flight path reporting data for UAV 2 provided by UE 4 of UAV 2 (STEP 502). DAF 14 checks the GMLC location data for UE 4 of UAV 2 against the flight path reporting data for UAV 2 provided by UE 4 of UAV 2, and determines if there is an inconsistency between the two (STEP 504). In response to detecting an inconsistency, DAF 14 reports the inconsistency to UAS-NF supported within NEF 18 (STEP 506). Otherwise, DAF 14 proceeds to check the flight path reporting data for UAV 2 from UE 4 for UAV 2 against the authorised flight path data from USS/UTM 22 indicating the authorised flight path for UAV 2 (STEP 508). In response to detecting an inconsistency between the flight path reporting data for UAV 2 from UE 4 for UAV 2 and the authorised flight path data from USS/UTM 22 indicating the authorised flight path for UAV 2, DAF 14 determines that UAV 2 has deviated from the authorised flight path for UAV 2, and reports the deviation to UAS-NF supported within NEF 18 (STEP 510 of FIG. 6 and OPERATION 216 of FIG. 3). Otherwise, DAF 14 continues to receive further GMLC location data for UE 4 and further flight path reporting data for UAV 2 from UE 4 for UAV 2, and repeats the checking process. Checking the flight path reporting data for UAV 2 from UE 4 for UAV 2 against the authorised flight path data indicating the authorised flight path for UAV 2 (STEP 508) may take into account information from US S/UTM 22 about an acceptable range of deviation. DAF 14 may determine that an inconsistency exists only if the extent of deviation between the flight path reporting data for UAV 2 from UE 4 for UAV 2 and the authorised flight path data indicating the authorised flight path for UAV 2 is outside the acceptable range of deviation. The size of the acceptable range of deviation may depend on one or more conditions (such as weather conditions); and DAF 14 may dynamically calculate an acceptable range of deviation according to one or more functions indicated in the information from USS/UTM 22 and one more input parameters for one or more conditions specified in the information from USS/UTM 22.

Returning to FIG. 3: in response to receiving a flight deviation report from DAF 14, UAS-NF supported within NEF 18 sends the flight deviation report to USS/UTM 22 (OPERATION 218 of FIG. 3). In this example, the flight path deviation report includes data indicating the degree of deviation from one or more way-points (intermediate points) of the authorised flight path in terms of distance or time, and data indicating the reliability of the determination of a deviation from the authorised flight path.

FIGS. 4 and 5 show a representation of another example of operations according to another example embodiment. This example is the same as that of FIGS. 2 and 3, except that DAF 14 (at OPERATION 204B of FIG. 4) sends the message to AMF 12 triggering AMF 12 to send a N2 message to RAN 8 triggering RAN 8 to configure UE 4 of UAV 2 for flight path reporting. FIG. 5 is the same as FIG. 3 - the subsequent operations at DAF 14 and UAS-NF supported within NEF 18 are the same for both examples.

In the examples described above, the UAS-NF supported within NEF 18 or DAF 14 sends a message to AMF 12 triggering the AMF 12 to send a message to RAN 8 triggering RAN 8 to configure UE 4 of UAV 2 for flight path reporting. According to one example variation, such message is omitted because RAN 8 has already configured UE 4 for flight path reporting in response to detecting during registration of UE 4 that UE 4 is an aerial UE. For example, UE 4 may be identified as an aerial UE using an aerial indication at the 3GPP subscription level.

According to one variation of the example described in detail above, the DAF 14 may alternatively or additionally use other data from the UAV-UE 4 that can indicate the flight path of UAV 2, to compare against the authorised flight path data from USS/UTM 22 to thereby check for deviations from the authorised flight path. For example, the DAF 14 may make a secondary use of location data included in Minimisation of Drive Tests (MDT) messages from UAV-UE 4, which are primarily used by the network for providing a clear view about network quality, radio signal coverage and network traffic localisation, in order to facilitate optimisation of network capacity and performance. The MDT messages comprise GPS location data correlated to radio events at UE 4.

According to one example, the DAF 14 compares the authorized flight path data received in the request from USS/UTM 22 with: (a) the flight path reporting data (from UAV-UE 4) retrieved from RAN 8; (b) the UE location report from GMLC 16 and (c) MDT data logs from RAN 8.

The above-described techniques provide verification for the USS/UTM 22 about whether UAV 2 is actually following the authorised flight path. This enables USS/UTM 22 to take better manage aerial traffic.

FIG. 7 illustrates an example of an apparatus for implementing the DAF 14 or NEF 18. The apparatus may comprise at least one processor 902 coupled to one or more interfaces 908 for communication with one or more other core network nodes.

The at least one processor 902 may also be coupled to at least one memory 906. The at least one processor 902 may be configured to execute an appropriate software code to perform the operations described above. The software code may be stored in the memory 906.

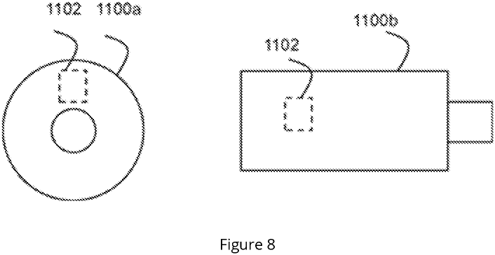

FIG. 8 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allow the processor to perform one or more of the steps of the methods described previously.

It is to be noted that embodiments of the present invention may be implemented as circuitry, in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as the base stations or user equipment of the above-described embodiments.

As used in this application, the term “circuitry” refers to all of the following: (a) hardware- only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as the user equipment or base stations of the above-described embodiments, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

That which is claimed:

1. Apparatus comprising: at least one processor; and at least one memory including computer program code, the at least one memory and computer program code configured to, with the at least one processor, cause the apparatus to perform:
receiving travel path data from a traffic management entity, wherein the travel path data indicates a travel path for a vehicle comprising a user equipment registered to a mobile communication system;
receiving location data for the vehicle transmitted by the user equipment; and
in response to detecting an inconsistency between the travel path data for the vehicle and the location data for the vehicle transmitted by the user equipment, outputting a travel path deviation report for the traffic management entity.

2. The apparatus according to claim 1, wherein the location data for the vehicle comprises travel path reporting data transmitted by the user equipment.

3. The apparatus according to claim 2, wherein the travel path reporting data transmitted by the user equipment is transmitted by the user equipment as one or more messages indicating the location and arrival time for one or more waypoints.

4. The apparatus according to claim 2, wherein the travel path reporting data is transmitted periodically by the user equipment.

5. The apparatus according to claim 1, wherein the location data for the vehicle comprises location data transmitted by the user equipment together with measurements related to the radio access network.

6. The apparatus according to claim 1, wherein the at least one memory and computer program code are configured to, with the at least one processor, cause the apparatus to: receive the travel path data from the traffic management entity from a network exposure function of a core network of the mobile communication system; and wherein configuration of the user equipment to transmit location data for the vehicle is triggered by a message from the network exposure function to an access management function for the user equipment.

7. The apparatus according to claim 1, wherein the at least one memory and computer program code are configured to, with the at least one processor, cause the apparatus to: send, to an access management function for the user equipment, a message triggering configuration of the user equipment to transmit location data for the vehicle.

8. The apparatus according to claim 1, wherein the at least one memory and computer program code are configured to, with the at least one processor, cause the apparatus to: receive the travel path data from the traffic management entity from a network exposure function of a core network of the mobile communication system; receive location data for the user equipment from a gateway location mobile centre; and, in response to detecting that the location data for the user equipment from the gateway location mobile centre is not consistent with the location data for the vehicle transmitted by the user equipment; report the inconsistency to the network exposure function.

9. The apparatus according to claim 1, wherein the vehicle is an aerial vehicle and the location data for the aerial vehicle transmitted by the user equipment indicates longitude, latitude and height of the aerial vehicle.

10. The apparatus according to claim 1, wherein the inconsistency between the travel path data for the vehicle from the traffic management entity and the location data for the vehicle transmitted by the user equipment comprises a deviation outside a threshold range of deviation.

11. The apparatus according to claim 10, wherein the threshold range of deviation is based on information from the traffic management entity.

12. The apparatus according to claim 1, wherein the apparatus comprises a network data analytics function or a management data analytics function of the mobile communication system.

13. Apparatus comprising: at least one processor; and at least one memory including computer program code, the at least one memory and computer program code configured to, with the at least one processor, cause the apparatus to perform:
receiving travel path data from a traffic management entity, wherein the travel path data indicates a travel path for a vehicle comprising a user equipment registered to a mobile communication system;
sending the travel path data to a data analytics function of a core network of the mobile communication system; and
in response to receiving a travel path deviation report from the data analytics function, sending the travel path deviation report to the traffic management entity.

14. The apparatus according to claim 13, wherein the at least one memory and computer program code are configured to, with the at least one processor, cause the apparatus to: in response to receiving the travel path data from the traffic management entity, send, to an access management function for the user equipment, a message triggering configuration of the user equipment to transmit location data for the vehicle, for use by the data analytics function to check against the travel path data.

15. The apparatus according to claim 14, wherein the location data for the vehicle comprises travel path reporting data for the vehicle.

16. The apparatus according to claim 15, wherein the message triggering configuration of the user equipment to transmit travel path reporting data comprises a message triggering the user equipment to send one or more messages indicating the location and arrival time for one or waypoints for the vehicle.

17. The apparatus according to claim 13, wherein the apparatus comprises a network function supported within a network exposure function of the mobile communication system.

18. The apparatus according to claim 13, wherein the vehicle is an aerial vehicle.

19. A method comprising:
receiving, at a data analytics function of a core network of a mobile communication system, travel path data from a traffic management entity, wherein the travel path data indicates a travel path for a vehicle comprising a user equipment registered to the mobile communication system;
receiving, at the data analytics function, location data for the vehicle transmitted by the user equipment; and
in response to detecting an inconsistency between the travel path data for the vehicle and the location data for the vehicle transmitted by the user equipment, outputting a travel path deviation report for the traffic management entity.

20. A method comprising:
receiving, at a network exposure function of a core network of a mobile communication system, travel path data from a traffic management entity, wherein the travel path data indicates a travel path for a vehicle comprising a user equipment registered to the mobile communication system;
sending the travel path data to a data analytics function of the core network; and in response to receiving a travel path deviation report from the data analytics function, sending the travel path deviation report to the traffic management entity.
